(19) United States
(12) Patent Application Publication
(10) Pub. No.: US 2015/0360739 A1
(43) Pub. Date: Dec. 17, 2015

(54) SYSTEM AND METHOD FOR SECURED PARKING OF BICYCLES

(71) Applicant: Eli Ashlag, Kiryat Ono (IL)

(72) Inventor: Eli Ashlag, Kiryat Ono (IL)

(73) Assignee: Goldratt group international, Limassol (CY)

(21) Appl. No.: 14/306,255

(22) Filed: Jun. 17, 2014

(51) Int. Cl. B62H 3/04; B62H 5/00; B62H 3/02

(52) U.S. Cl. CPC B62H 3/04; B62H 3/02; B62H 5/005

(57) ABSTRACT

A bicycle parking system is associated with the ground, and having several bicycle positions. A bicycle position includes a pair of tire support members, an affixing member for affixing the bicycle, aligning mechanisms for fixedly placing the affixing member relative to the bicycle and relative to the ground, and a locking mechanism for securing the aligning mechanisms from unauthorized release of the bicycle from the parking system. The pair of tire support members support the tires of the bicycle, and limit a sidewise motion of each tire of the a bicycle to either side. A projected member affixes the cross bar of the bicycle to the affixing member and is rotatable within a predetermined angular range around an axis transverse to the length of the affixing member. The affixing member is rotatable within a predetermined range around an axis located in its bottom part. It is also expandable in length within a predetermined range using an electric motor, and positioned substantially uprightly aside a space between the two tire support members. Usually, the parking system is publicly accessible, and a secured mechanism limits the access to a locking mechanism to an individual user, thus securing the aligning mechanism.

### BACKGROUND OF THE INVENTION

1. Field of the Invention

The invention is in the field of parking facilities for bicycles in a street, and especially deals with preventing stealing a parking bicycle or a tire thereof.

2. Description of Related Art

Parking bicycle in a public may be an easy task for the rider, as some post, fence, or a tree may be used to lock the bicycle to fixed element by circumventing a fixed element and a part of the bicycle together by a metallic cable and thus prevent its stealing. Moreover, city halls or municipal authorities provide special apparatus for parking bicycles such that the owner knows that she is parking her bicycle in a place intended for that use, without interfering people walking on a pavement, etc.

Unfortunately, a bicycle locked this way is exposed to several dangers. First, the locking device may be broken easily by a thief. Secondly, a thief may cut the metallic cable using special cutter. Thirdly, rather than stealing the whole bicycle, a thief takes one of the wheels.

In addition, the bicycle rider has to take with him a chain and a lock. Thus, there is a need for a secured bicycles parking with minimal load on the rider.

### BRIEF SUMMARY OF THE INVENTION

It is provided according to preferred embodiments of the present application, a bicycle parking system associated with the ground, and having several bicycle positions. A bicycle position includes a pair of tire support members, an affixing member, connected to the ground, for affixing the bicycle, aligning mechanisms for fixedly placing the affixing member relative to the bicycle and relative to the ground, and a locking mechanism for securing the aligning mechanisms from unauthorized release of the bicycle from the parking system. The pair of tire support members support the tires of the bicycle, and limit a sidewise motion of each tire of the bicycle to either side.

In some embodiments, the affixing member includes a projected member adapted for affixing the bicycle to the affixing member, and limit motion of the bicycle in at least one direction. Preferably, the projected member is rotatable within a predetermined angular range around an axis transverse to the length of the affixing member.

In some embodiments, a metal construction serves as a base for the pair of tire supports, and is associated to the ground by its weight.

In some embodiments, a construction is shaped to include the pair of tire supports and is attached fixedly to the ground. The material of at least most of its volume is non-metallic.

In some embodiments, the affixing member is rotatable within a predetermined range around an axis located in its bottom part.

In some embodiments, the affixing member is expandable in length within a predetermined range. Preferably, an electric motor affects the length.

In some embodiments, the affixing member is positioned substantially uprightly aside a space between the two tire support members.

In some embodiments, a locking mechanism secures all the aligning mechanisms.

In some embodiments, a location of the parking system is publicly accessible, and a secured mechanism limits the access to the locking mechanism to an individual user.

In some embodiments, the affixing member affixes a horizontal cross bar of the bicycle.

It is provided according to preferred embodiments of the present application, a method for bicycle parking. The system has several bicycle positions. The method includes associating a parking system to the ground, and placing a bicycle in a position such that its tires are supported by a pair of tire support members, and a sidewise motion of each tire to either side is limited. The method further includes fixedly aligning an affixing part of the bicycle position relative to the bicycle and relative to the ground, affixing the bicycle to the affixing part such that motion of the bicycle is limited, and applying a locking mechanism for preventing unauthorized release of the bicycle from the parking system.

In some embodiments, the affixing part includes a projected member, and the method includes affixing the bicycle to the projected member. Preferably, the method includes rotating the projected member within a predetermined angular range around an axis transverse to a longest direction of the affixing part.

In some embodiments, the method includes rotating the affixing part around its bottom portion within a predetermined range.

In some embodiments, the method includes tuning a length of the affixing part within a predetermined range. Preferably, the method includes operating an electric motor to affect the length.

In some embodiments, a location of the parking system is accessible to the public, and the method includes associating a certain bicycle position with a personal identification means to allow an exclusive access to operating the bicycle position to a person linked up with the personal identification means. The method also includes a step of dissociating the bicycle position from the personal identification means to enable associating with another personal identification means. Exemplary personal identification means are radio frequency identification card(RFID), and a pre-registered biometric identifier.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1a illustrates a metal base for several bicycle parking positions with two bicycles parking in respective adjacent positions.

FIG. 1b illustrates a bicycle in a bicycle parking position.

FIG. 2a shows an affixing post uprightly erected from the metal base and having a projected fastener.

FIG. 2b exhibits a rotation of the affixing post around an axis at its bottom part.

FIG. 2c exhibits two states of the affixing post at respective two heights.

FIG. 2d is an exploded view of the affixing post and the projected fastener.

FIGS. 3 and 4 show a first mechanism for tuning the length of the affixing post.

FIG. 3a is a side view of the affixing post.

FIG. 3b is a sectional side view of the affixing post.

FIG. 3e is an enlarged view of the first mechanism.

FIG. 4 is an isometric view of the first mechanism.

FIG. 5 shows a second mechanism for tuning the length of the affixing post.

FIG. 5a is an isometric transparent view of the affixing post with the manipulating motor.

FIG. 5b is a first side view of the motor manipulated affixing post.

FIG. 5c is a second side view of the motor manipulated affixing post.

FIG. 6a illustrates a concrete base for several bicycle parking positions with two parking bicycles in respective bicycle positions.

FIG. 6b is an enlarged view of a single bicycle position shaped in the concrete base.

FIG. 7 is a block diagram of an electronic system for accessing bicycle position by an RFID holder.

FIG. 8 is a flow chart of a method for secured bicycle parking.

### DETAILED DESCRIPTION OF THE INVENTION

The present invention will now be described in terms of specific example embodiments. It is to be understood that the invention is not limited to the example embodiments disclosed. It should also be understood that not every feature of the methods and systems handling the described apparatus is necessary to implement the invention as claimed in any particular one of the appended claims. Various elements and features of devices are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

Two embodiments of a secured system for parking bicycles in a public place are described, followed by a method for parking bicycles in the system.

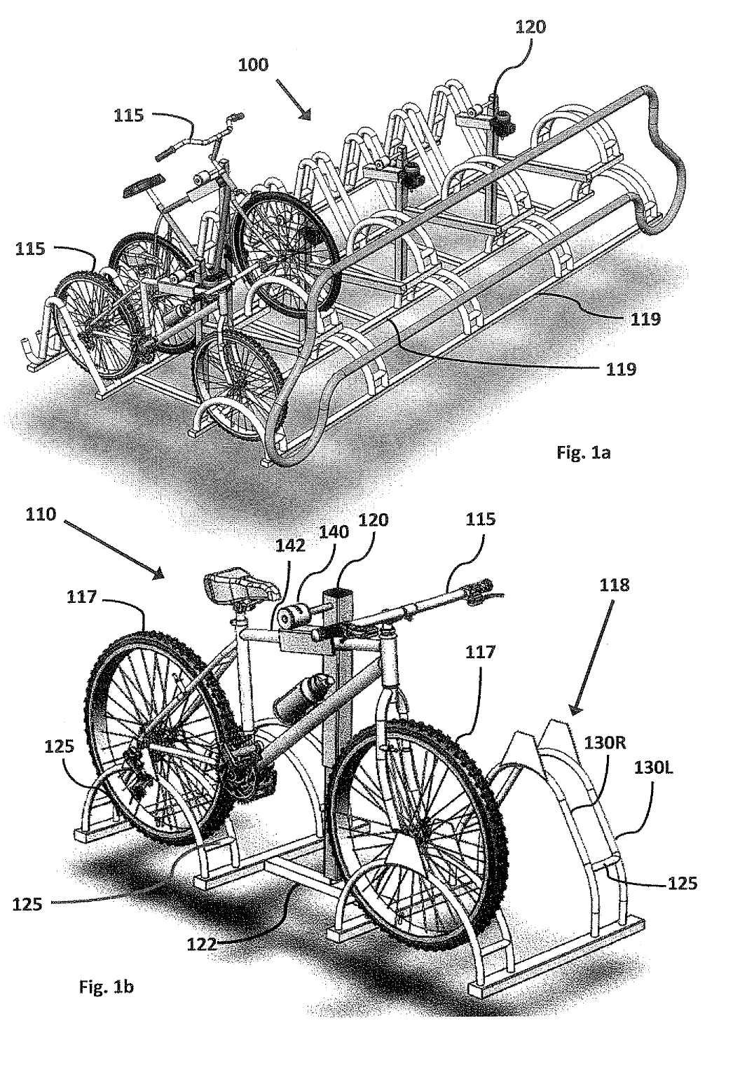

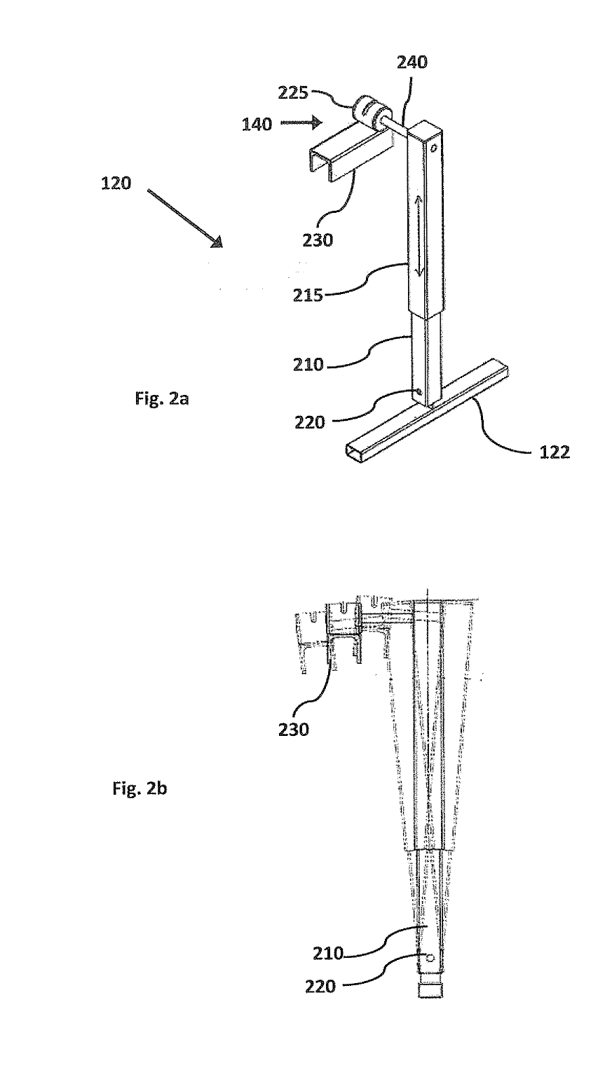

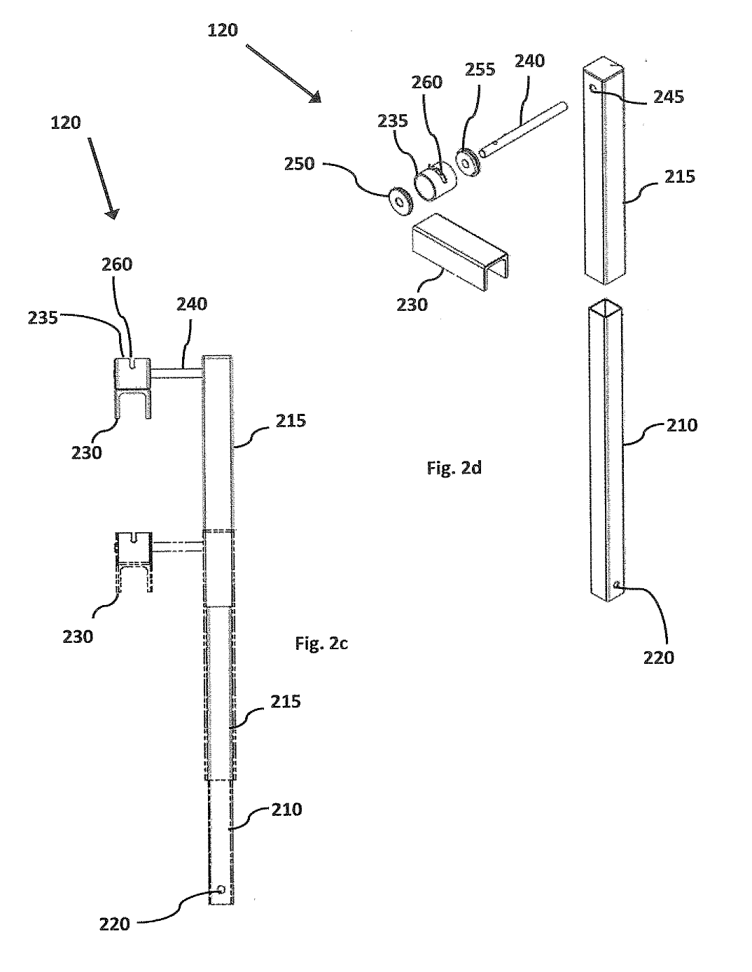

### A Metallic Bicycle Parking System (FIGS. 1-2)

FIGS. 1a and 1b show a system 100 for parking bicycles 115. System 100 has a metal construction base associated to the ground by its weight, and includes several bicycle positions 110. A bicycle position 110 includes two support members 118 for a respective pair of tires 117, an affixing post 120 for affixing the bicycle, aligning mechanisms for fixedly placing the affixing member 120 relative to bicycle 115 and relative to the ground, and a locking mechanism for securing the aligning mechanisms from unauthorized release of the bicycle from the parking system.

Support member 118 of a front tire 117 includes two arcs 130R and 130L projection from two long bars 119 and connected to each other by two horizontal rods 125, where tire 117 rests upon at least one of rods 125. Arcs 130R and 130L limit a sidewise motion of tire 117 to either side.

Affixing post 120 is positioned substantially uprightly aside a space between a front tire support member 118 and a rear tire support 118.

Affixing post 120 is fixed to the ground by its connection to a bar 122 which connects two internal long bars 119. A fastener 140 is projected from post 120 for keeping bicycle 115 in place by affixing it to affixing post 120. Thus, limiting motion of bicycle 115 in the upwards direction. In the embodiment of FIG. 1b, projected fastener 140 holds down an horizontal cross bar 142 of bicycle 115.

At least two rods 125 couple the upwards motion of bicycle 115 with backwards-forwards motion. Thus, bicycle 115 is confined from moving in all directions, and a thief is prevented from taking the frame of the bicycle or even a wheel.

Referring now to FIGS. 2a and 2b, affixing post 120 is rotatable within a predetermined range ±Z around an axis 220 located at a bottom part 210. A typical Z value is less than 15°, preferably less than 10° and most preferably less than 5°.

Post 120 has also an upper part 215 which is slidable over bottom part 210 such that post 120 is expandable in length within a predetermined range as shown in FIG. 2c. Several expansion mechanisms are described below. The expansion range may be less than 75 cm, preferably less than 50 cm and more than 20 cm.

Referring to the exploded view of FIG. 2d, projected member 140 is connected to post 120 by a transversal rod 240, which enters into a cylinder 235. Cylinder 235 is free to rotate around rod 240 within a predetermined range, and is attached to holder 230. Rings 250 and 255 close cylinder 235 in respective ends.

Cylinder 235 has a slotted arc 260 for a screw with a wide head(not shown) connected to rod 240 inside cylinder 235. Thus, the rotational motion of cylinder 235 is limited by the angular range of slotted arc 260. In an exemplary embodiment, the rotational range is less than 60°. Preferably, the rotational range is less than 30°.

Holder 230 is an elongated element having an open rectangular cross-section such as to catch cross bar 142 by downwards pressure, such as to prevent sidewise motion of cross bar 142.

FIG. 1a shows two adjacent bicycle position whereas the left bicycle (from a front viewpoint) is parked horizontally such that the two tires or wheels 117 are at the same height above ground and cross bar 142 is horizontal. The right bicycle is parked in a slope having a front tire 117 higher than the rear tire. The respective affixing members 120 may be fitted to these two different slop situations either by a different design or by use of alignment range of sufficient size.

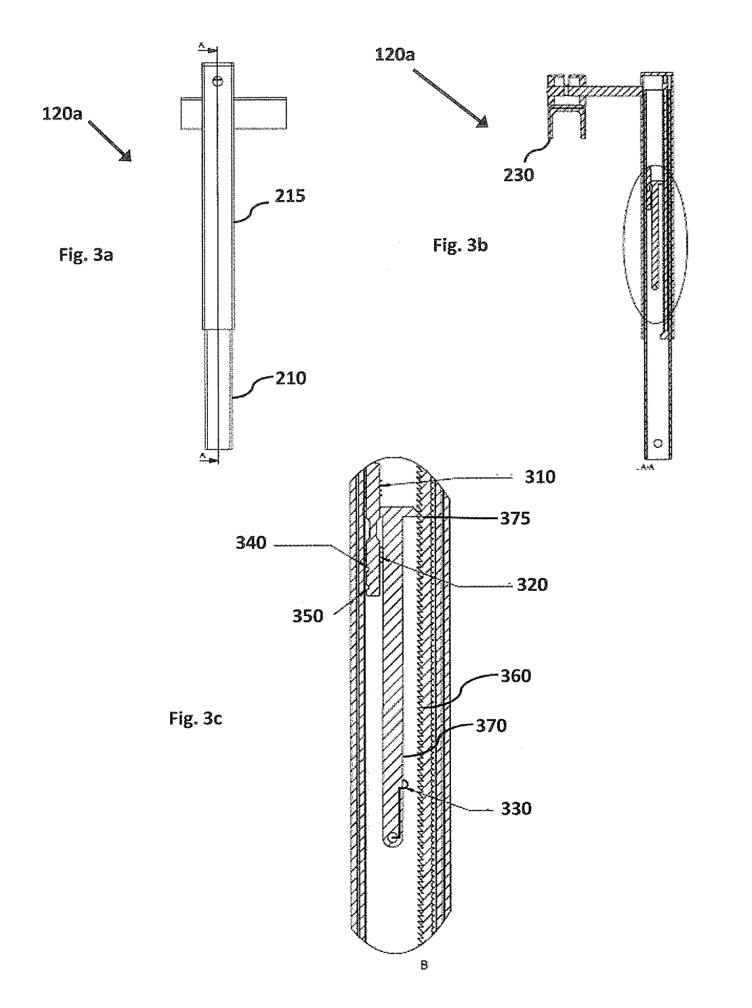

### Embodiments of Expansion Mechanisms of the Affixing Post (FIGS. 3-5)

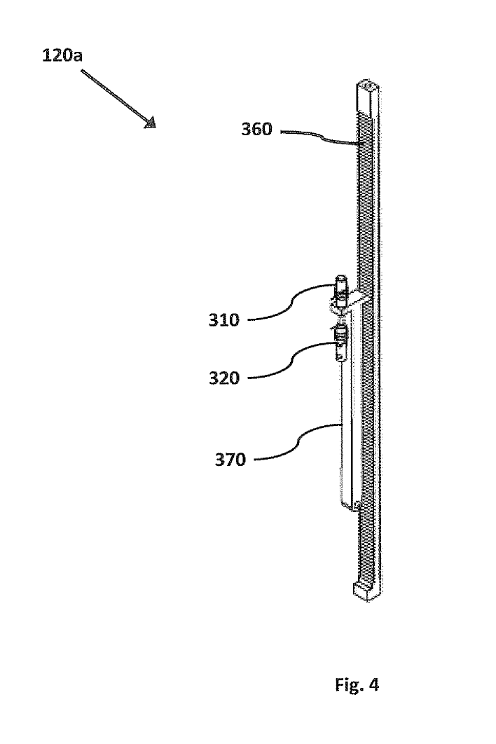

Two embodiments of expansion mechanisms of affixing post 120 are illustrated in FIGS. 3-5. The first mechanism is described in FIGS. 3 and 4, and is based on a telescopic rail, as well known in the art. FIG. 3a is a side view of an affixing post 120a. FIG. 3b is a sectional side view of affixing post 120a. FIG. 3c is an enlarged view of an electrically controlled manual tuning mechanism in FIG. 3b. The mechanism includes an opening coil 310, a closing coil 320, a closing state axis holder 340, an opening state axis holder 350, a helix 330 and a teeth rail 360. FIG. 4 is an isometric view of the mechanism for length tuning.

Teeth rail 360 is attached to upper part 215 while sliding rider 370 is coupled to lower post part 210. Initially, the bicycle rider activated opening coil 310, a tooth 375 of sliding rider 370 is placed slightly away of teeth rail 360, and part 215 may be moved upward or downward manually with slight force to overcome some friction. However, when part 215 is left untouched, it stays in place. Whenever the post height is appropriate, the bicycle rider activates closing coil 320, tooth 375 approaches teeth rail 360, and part 215 is locked in place.

Helix 330 ensures that tooth 375 is placed away of

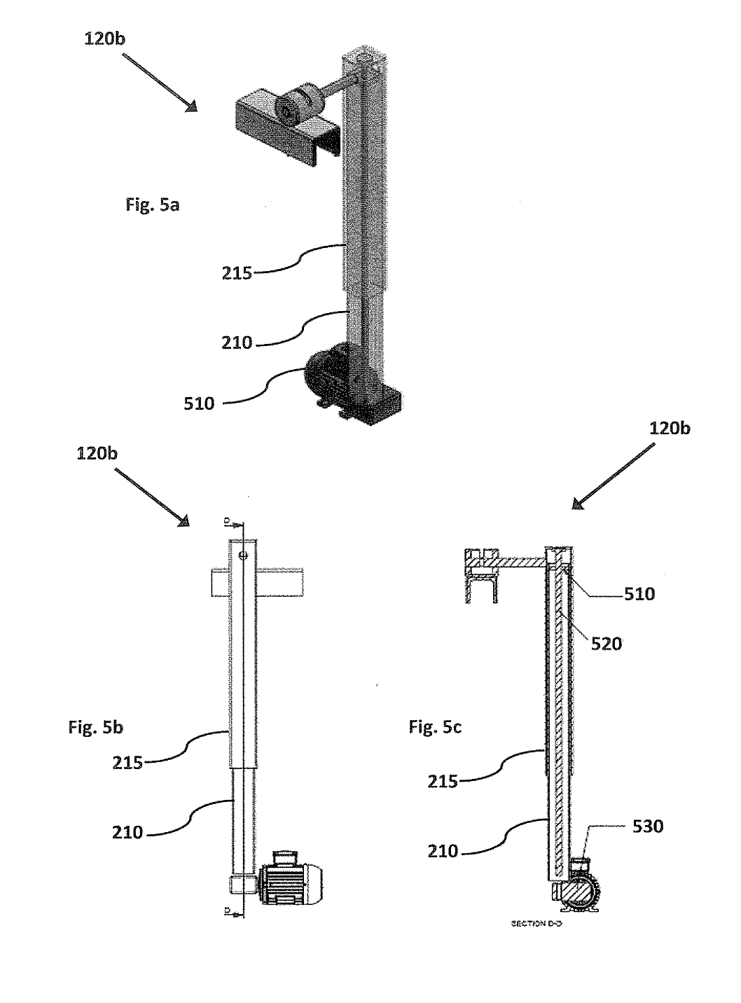

FIG. 5 shows a third mechanism for tuning the length of an affixing post 120b. FIG. 5a is an isometric transparent view of affixing post 120b with a manipulating motor 510. FIG. 5b is a first side view of motor 510 and post 120b. FIG. 5c is a second side view of motor 510 and affixing post 120b.

Threaded rod 520 is attached to part 210 and may be rotated by motor 530. A threaded nut 510 is attached to upper part 215 which is not able to rotate over part 210. Thus, rotation of threaded rod 520 enforces part 215 to move upwards or downwards in accordance with the direction of the rotation.

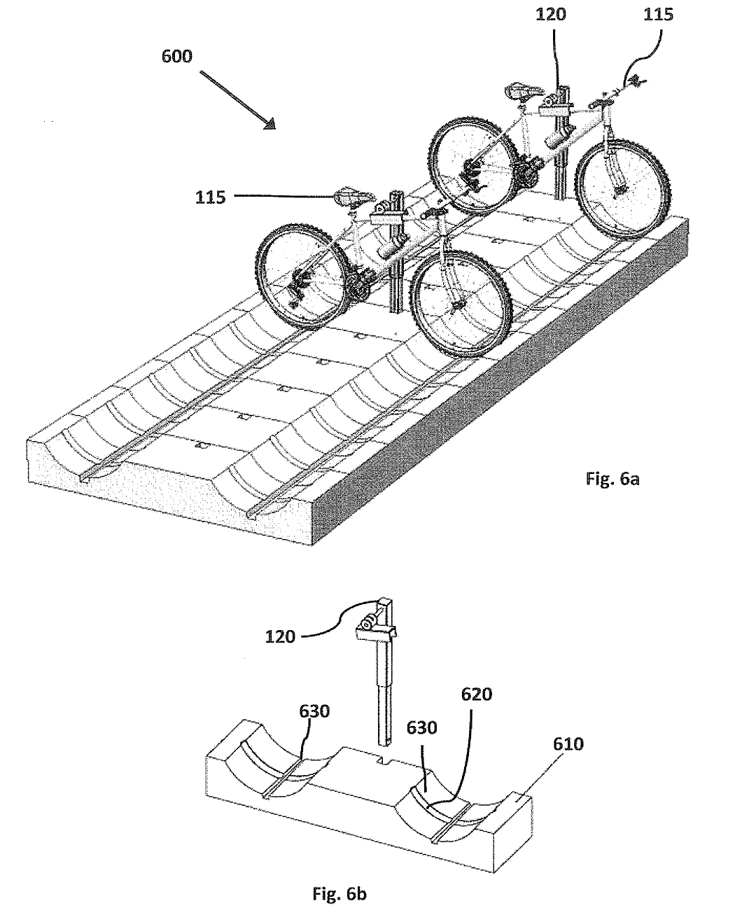

### A Concrete Embodiment of a Bicycle Parking System (FIG. 6)

Referring to FIGS. 6a and 6b, a concrete construction 600 is shaped such as to include several pairs of tire supports 620 and is attached fixedly to the ground by its weight or by additional means known in the art. Support 620 is a recessed arc within the concrete body 610 shaped such as to receive a tire 117. Affixing post 120 is attached fixedly to construction 600.

Recessed arc 620 is deep and narrow such that tire 117 is not free to move aside. Exemplary deepness of support 620 relative to an adjacent close portion of a curved surface 640 is in the range of 2-10 cm, preferably 3-8 cm. Typical width of recessed arc 620 in its upper part is in the range of 4-10 cm, preferable 5-8 cm. The cross section of recessed arc 620 is an arc or a U shape.

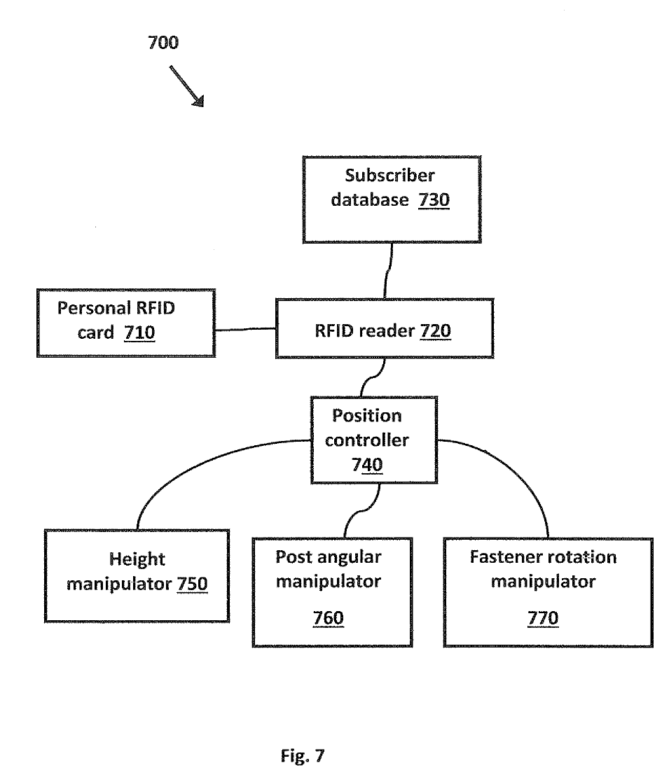

### An Electronic System for Accessing Bicycle Position by an RFID Holder (FIG. 7)

Usually, a location of the parking system is publicly accessible, and thus a secured mechanism is required to limit the access to locking mechanism of a bicycle 115 to an individual user. To this aim, all the aligning mechanisms may be controlled by a position controller 740, as shown in FIG. 7. Such a controller may be located in a special box in position 110 (not shown) and connected by wires to electrically operated alignment mechanisms. Controller 740 controls a post height manipulator 750, a post angular manipulator 760 and a rotation manipulator 770 of projected fastener rotation manipulator 770 by either permitting their manual manipulation or by operating respective electrical engines which causes a desired motion.

To control position controller 740, an RFID reader 720 senses the presence of a bicycle rider having a registered RFID 710 in her possession and read the identification data on card 710. The identification data is submitted for approval to a subscriber database 730 over a wired communication channel or wirelessly. Once the rider is identified as a subscriber of the municipal parking system, an approval is sent to RFID reader 720, and position controller 740 gets an order to allow the rider an access to position 110.

Once bicycle 115 is released from position 110, controller 740 gets appropriate signals from the manipulators 750, 760 and 770 that bicycle 115 has left position 110, and position 110 is dissociated from a first RFID 710, such that it may associate another rider with a second RFID 710.

An alternative personal identification means is a biometric identification means, like a fingerprint reader or an eye identifier.

In another embodiment, a certain parking period is purchased by the bicycle rider in a vending machine using a credit card or coins, for example. When that certain parking time elapses, the parking position is released for use by another rider.

In additional embodiment, the rider gets a temporary code for locking the parking position, by some purchasing procedure, a smart phone application for example.

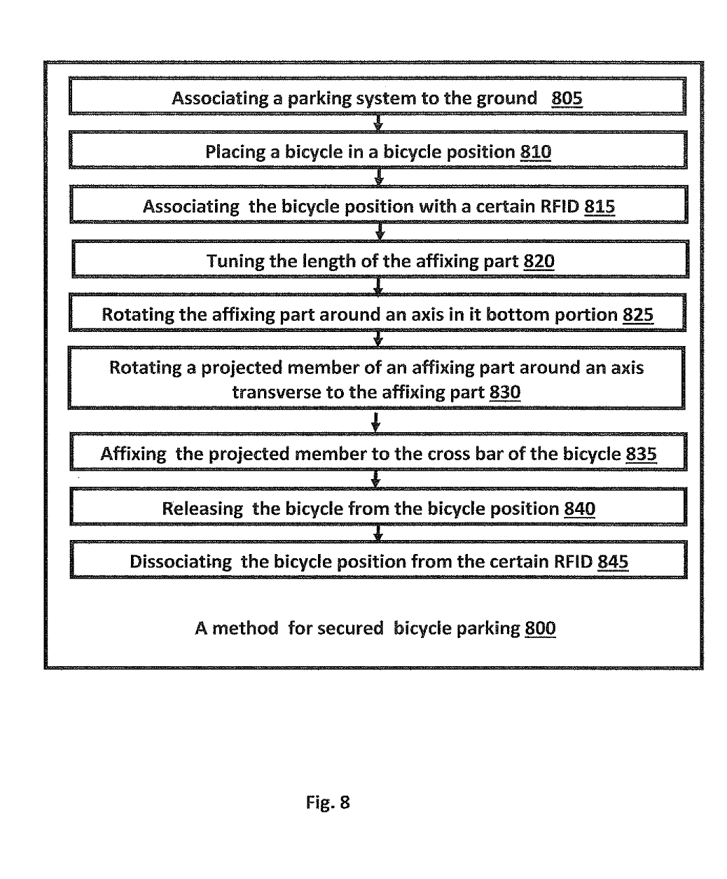

### A Method for Secured Bicycle Parking (FIG. 8)

Reference is now made to FIG. 8 which presents a method 800 for bicycle parking in a system 100. System 100 has several bicycle positions 110. Method 800 includes a step 805 of associating parking system 100 to the ground, and a step 810 of placing a bicycle 115 in a position 110 such that its tires 117 are supported by a pair of tire support members 620, and a sidewise motion of each tire 117 to either side is limited.

Usually, a location of parking system 100 is accessible to the public, and the method includes a step 815 of associating a bicycle position 110 with an RF identification card 710 to allow an exclusive access to operating bicycle position 110 to a person having RFID 710.

The method further includes fixedly aligning an affixing part 120 of the bicycle position 110 relative to bicycle 115 and relative to the ground, which step may be executed by any or all of the three following actions:
1. A step 820 of tuning a length of affixing part 120 within a predetermined range.
2. A step 825 of rotating affixing part 120 around an axis 220 in its bottom portion 210 within a predetermined range.
3. A step 830 of rotating a projected member 140 within a predetermined angular range around an axis transverse to a longest direction of affixing part 120.

Method 800 further includes a step 835 of affixing bicycle 115 to affixing part 120 or projected fastener 140, a step 840 of releasing bicycle 115 from bicycle position 110, and a step 845 of dissociating bicycle position 110 from RFID 710 of a certain person to enable its associating with an RFID 710 of another person.

The combined effect of step 815 of associating bicycle position 110 to a certain RFID 710 and step 845 of dissociating position 110 from RFID 710 is a locking mechanism for preventing unauthorized release of bicycle 115 from parking system 100.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the examples described.

1. A bicycle parking system, at least a part of the system being associated with the ground, the system having one or more bicycle positions, a bicycle position including:
(a) a pair of tire support members adapted to:
(i) support tires of a bicycle; and
(ii) limit a sidewise motion of each tire of said a bicycle to either side;
(b) an affixing member connected to the at least a part of the system associated with the ground for affixing said bicycle;
(c) one or more aligning mechanisms for fixedly placing at least a part of said affixing member relative to said bicycle and relative to said at least a part of the system associated with the ground; and
(d) at least one locking mechanism for securing at least one of the aligning mechanisms from unauthorized release of said bicycle from the parking system.

2. The system of claim 1 wherein said affixing member includes a projected member adapted for:
(A) affixing said bicycle to said affixing member; and
(B) limiting motion of said bicycle in at least one direction.

3. The system of claim 2 wherein said projected member is rotatable within a predetermined angular range around an axis transverse to a length of said affixing member.

4. The system of claim 1 wherein a metal construction serves as a base for said pair of tire supports, and is associated to the ground by its weight.

5. The system of claim 1 wherein a construction is shaped to include said pair of tire supports, said construction is attached fixedly to the ground, and a material of at least most of its volume is non-metallic.

6. The system of claim 1 wherein said affixing member is rotatable within a predetermined range around an axis located in its bottom part.

7. The system of claim 1 wherein said affixing member is expandable in length within a predetermined range.

8. The system of claim 7 wherein an electric motor affects said length.

9. The system of claim 1 wherein said affixing member is positioned substantially uprightly aside a space between said two tire support members.

10. The system of claim 1 wherein one or more locking mechanisms secure all of said one or more aligning mechanisms.

11. The system of claim 1 wherein a location of said parking system is publicly accessible, and a secured mechanism limits the access to said at least one locking mechanism to an individual user.

12. The system of claim 1 wherein said affixing member affixes a cross bar of said bicycle, said cross bar is substantially horizontal.

13. A method for bicycle parking comprising:
(a) associating a parking system to the ground, the system having one or more bicycle positions;
(b) placing a bicycle in a bicycle position such that:
(i) tires of said bicycle being supported by a pair of tire support members; and
(ii) a sidewise motion of each tire to either side being limited;
(c) fixedly aligning at least a part of an affixing part of said bicycle position relative to said bicycle and relative to said at least a part of the system associated with the ground;
(d) affixing said bicycle to said affixing part such that motion of said bicycle being limited;
(e) applying at least one locking mechanism for preventing unauthorized release of said bicycle from the parking system.

14. The method of claim 13 wherein said affixing part includes a projected member, and the method includes affixing said bicycle to said projected member.

15. The method of claim 14 wherein the method includes rotating said projected member within a predetermined angular range around an axis transverse to a longest direction of said affixing part.

16. The method of claim 13 wherein the method includes rotating said affixing part around its bottom portion within a predetermined range.

17. The method of claim 13 wherein said method includes tuning a length of said affixing part within a predetermined range.

18. The method of claim 17 wherein the method includes operating an electric motor to affect said length.

19. The method of claim 13 wherein a location of said parking system is accessible to the public, and the method includes:
(i) associating a certain bicycle position with a first personal identification means to allow an exclusive access to operating said certain bicycle position to a first person linked up with said first personal identification means; and
(ii) dissociating said_certain bicycle position from said first personal identification means to enable said certain bicycle position to associate a second personal identification means linked up with a second person.

20. The method of claim 19 wherein the personal identification means is selected from a group of personal identification means consisting of
(A) radio frequency identification card; and
(B) a pre-registered biometric identifier.
